(19) United States
(12) Patent Application Publication
(10) Pub. No.: US 2007/0207661 A1
(43) Pub. Date: Sep. 6, 2007

(54) Audio Extension Cord, Headset, Audio Arrangement Thereof, And Method Of Attaching Audio Extension Cord

(75) Inventor: Itzhak Pomerantz, Kfar Saba (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: SanDisk IL Ltd., Kfar Saba (IL)

(21) Appl. No.: 11/681,794

(22) Filed: Mar. 5, 2007

Related U.S. Application Data
(60) Provisional application No. 60/779,043, filed on Mar. 6, 2006.

(51) Int. Cl. H01R 11/20

(52) U.S. Cl. 439/427

(57) ABSTRACT

The present audio arrangement of a headset and an audio extension cord enables a user to listen to a portable audio player while essentially eliminating the risk that the audio extension cord would become tangled with exterior objects. The audio extension cord attaches to the user's shirt and provides to the headset a signal path from the portable audio player, which is attached at the waist or on the arm. No modification of a standard portable audio player is necessary, which thus provides widespread applicability. The invention can also be embodied as a method of attaching an audio extension cord to a shirt in a fashion to facilitate listening to a portable audio player with a nearly eliminated risk that the audio extension cord would encumber nearby objects.

### RELATED APPLICATION

This application claims priority under 35 U.S.C. § 119(e) to U.S. Provisional Application No. 60/779,043, filed Mar. 6, 2006, which is hereby incorporated by reference in its entirety

### BACKGROUND

A portable audio player permits a user to listen to prerecorded or live audio programming without the constraint of maintaining a fixed location. Examples of such portable audio players are portable radios, disk players, and MP3 players. When a portable audio player channels its output to a personal headset, a user may listen to audio programming while riding in public transportation, when studying in public libraries, or while exercising. However, for at least some uses, such as certain types of exercises, special concerns arise as follows:

FIG. 1 illustrates a user operating a prior art audio arrangement. The figure shows a user 10 listening to a portable audio player 12, which she holds in her hand. Portable audio player 12 sends its output via an audio extension cord 14 to a headset 16, which has two earphones (one not visible in FIG. 1). To facilitate certain types of exercises, user 10 may clip portable audio player 12 to her belt or strap it to one of her arms, either at the biceps or near the wrist.

However, audio extension cord 14 remains loosely dangling between headset 16 and portable audio player 12, which raises the potential of the problem of audio extension cord 14 becoming tangled with nearby objects. Even if tucked inside the user's coat, leaving enough slack in audio extension cord 14 to allow free neck movement increases the likelihood that the cord would wrap around shirt buttons, zippers, pens, and so on clipped in shirt pockets.

The problems of loose audio extension cords are not limited to athletic activities. For example, the potential for an audio extension cord to wrap around a nearby object may arise while gardening. Thus, a need exists for a way to listen to a portable audio player without the significant risk that the audio extension cord would become tangled with nearby objects.

### SUMMARY

The present invention enables a user to listen to a portable audio player while essentially eliminating the risk that the audio extension cord would become tangled with nearby objects. The invention does not require a specially-designed portable audio player, so the user may continue to enjoy prior art portable audio players. The invention may be embodied as an audio extension cord, a headset, an audio arrangement including both an audio extension cord and headset, and a method of attaching an audio extension cord in a fashion to facilitate listening to a portable audio player.

The inventive audio extension cord includes a set of electrical leads, a lower electrical connector connected to a bottom end of the set of leads, a first upper electrical connector connected to a first upper end of the set of leads, and a fastener configured to fasten the electrical leads to a shirt such that the audio extension cord can connect a portable audio player, located at or near a side or lower boundary of the shirt, to an earphone located at or near a neck area of the shirt. The fastener extends along the majority of the length of the set of leads and is sized and shaped: (1) to position the lower electrical connector in the vicinity of the side or lower boundary of the shirt, and (2) to position upper electrical connectors in the vicinity of the neck area of the shirt. Some embodiments of the audio extension cord also have a second upper electrical connector connected to a second upper end of the set of leads. The lower electrical connector is compatible with an output connector of the portable audio player, the first upper electrical connector is compatible with a connector of an earphone, and the second upper electrical connector is compatible with a connector of another earphone.

The inventive headset has at least one earphone such that a first set of leads connects a first speaker to a first female connector. Some embodiments of the headset also have a second set of leads that connects a second speaker to a second female connector. The sets of lead may sized to have a length less than 25 cm.

The inventive audio arrangement has a headset and an audio extension cord. The headset has at least one earphone and a first headset connector. In some embodiments of the audio arrangement, the headset also has a second headset connector. The audio extension cord has a set of electrical leads, a lower electrical connector, a first upper electrical connector, optionally a second upper electrical connector, and a fastener as discussed above. In the inventive audio arrangement, the first upper electrical connector of the audio extension cord is compatible with the first headset connector, and, in embodiments having an audio extension cord with a second upper electrical connector, the second upper electrical connector is compatible with the second headset connector.

The inventive method of attaching an audio extension cord to a shirt includes: sewing a set of electrical leads to extend from the vicinity of the side or lower boundary of the shirt to the vicinity of a neck area of the shirt; connecting a lower electrical connector to a bottom end of the leads; and connecting a first upper electrical connector to a first upper end of said set of leads. Some embodiments of the method include connecting a second upper electrical connector to a second upper end of the leads. The lower electrical connector is compatible with an output connector of the portable audio player, the first upper electrical connector is compatible with an electrical connector of a first earphone, and the second upper electrical connector is compatible with an electrical connector of a second earphone. In some embodiments, the sewing is effected by leading a thread through the shirt and wrapping the thread around the leads. In other embodiments, the sewing is effected by leading the leads through the shirt. Such sewing may be effected by attaching a tapered cap to the lower electrical connector, an upper electrical connector, or to both.

Embodiments of the present invention are described in detail below with reference to the accompanying drawings, which are briefly described as follows:

### BRIEF DESCRIPTION OF THE DRAWINGS

The invention is described below in the appended claims, which are read in view of the accompanying description including the following drawings, wherein:

FIG. 1 illustrates a user operating a prior art audio arrangement;

FIG. 2A illustrates an audio arrangement in accordance with one embodiment of the invention;

FIG. 2B illustrates an audio arrangement in accordance with an alternate embodiment of the invention;

FIG. 3 illustrates an audio extension cord in accordance with an embodiment of the invention;

FIG. 4 illustrates an arrangement of electrical leads of an audio extension cord in accordance with an embodiment of the invention;

FIGS. 5A and 5B show a side and front view, respectively, of an embodiment of an upper electrical connector of an audio extension cord in accordance with one embodiment of the invention;

FIGS. 6A and 6B show a side and front view, respectively, of a headset connector corresponding to the embodiment of FIGS. 5A and 5B;

FIG. 7 illustrates a segment of electrical leads sewn to a shirt in accordance with one embodiment of the invention;

FIG. 8 illustrates a segment of electrical leads sewn to a shirt in accordance with an alternate embodiment of the invention; and

FIGS. 9A and 9B show unassembled and assembled views, respectively, of an electrical connector and a tapered cap, which acts as a needle for leading the electrical leads through the shirt fabric, which may be expedient for the embodiment of FIG. 8.

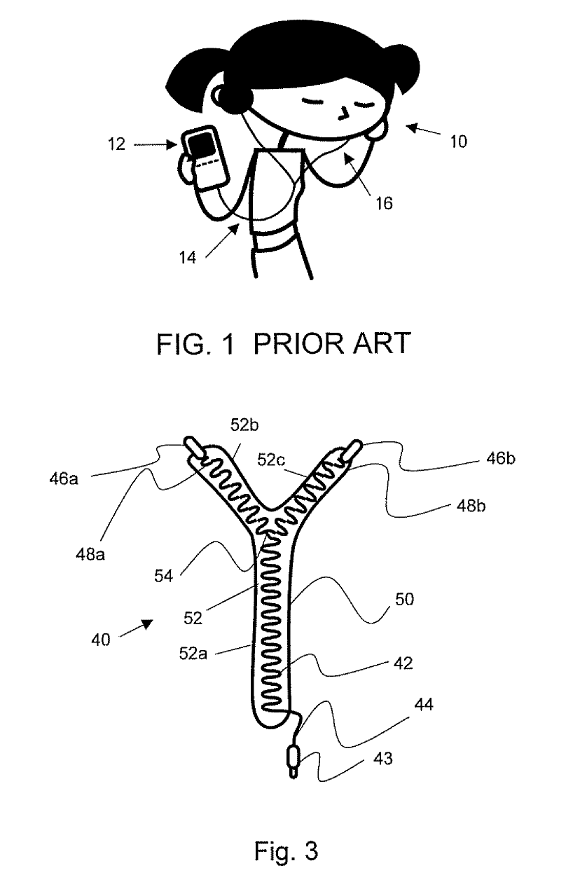

### DETAILED DESCRIPTION

The invention summarized above and defined by the claims below will be better understood by referring to the present detailed description of embodiments of the invention. This description is not intended to limit the scope of claims but instead to provide examples of the invention. Described first are embodiments of audio arrangements in accordance with the invention. Details are provided regarding various headsets and audio extension cords that exemplify the audio arrangements. Also discussed are methods of attaching an audio extension cord in accordance with the invention to facilitate listening to a portable audio player.

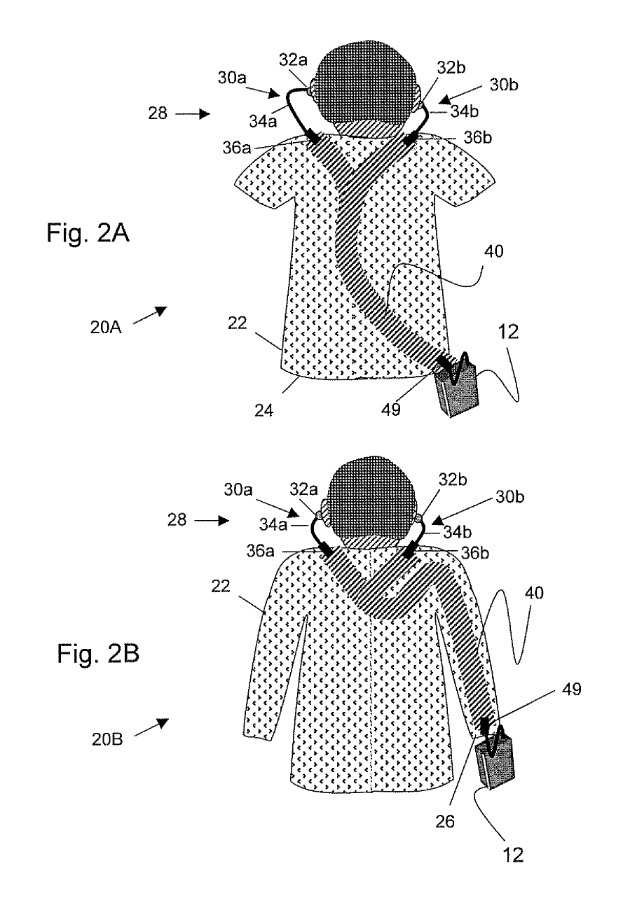

FIG. 2A illustrates an embodiment of the invention in which an audio arrangement 20A adapts a shirt 22 to facilitate listening to portable audio player 12, which is located at or near a lower boundary 24 of shirt 22. FIG. 2B depicts an alternate embodiment in which an audio arrangement 20B adapts shirt 22 to facilitate listening to portable audio player 12 located at or near a side boundary 26 of shirt 22. The term “shirt” is used in the present disclosure broadly to include long- and short-sleeved garments, tank tops, bare midriffs, undershirts, sweaters, or any other similar article of clothing worn on the upper half of the body

Audio arrangements 20A, 20B each include a headset 28. In the embodiments of FIGS. 2A and 2B, headset 28 has two earphones 30a, 30b, each of which includes a speaker 32a/32b and a set of electrical leads 34a/34b, respectively. Headset 28 also has two corresponding headset connectors 36a, 36b, respectively. In other embodiments of the invention, the headset may have only one earphone and headset connector. In both embodiments, a headset is configured such that a set of leads connects the speaker to the headset connectors.

Audio arrangements 20A, 20B also each have an audio extension cord 40, which is illustrated in detail in FIG. 3. (For clarity, FIGS. 2A and 2B provide only a high-level view of audio extension cord 40). Audio extension cord 40 includes a set of electrical leads and connectors as follows: electrical leads 42 are connected to a lower electrical connector 43 at their bottom end 44, to a first upper electrical connector 46a at their first upper end 48a, and to a second upper electrical connector 46b at their second upper end 48b. Lower electrical connector 43 is compatible with an output connector 49 (FIGS. 2A and B) of portable audio player 12. First upper electrical connector 46a is compatible with headset connector 36a (FIGS. 2A and B), and second upper electrical connector 46b is compatible with headset connector 36b (FIGS. 2A and B).

Audio extension cord 40 also has a fastener 50, which is configured to fasten electrical leads 42 to shirt 22. Electrical leads 42 may be attached to fastener 50 by sewing or by adhesive. As is clear from FIG. 3, fastener 50 extends along the majority of the length of electrical leads 42. Although the fasteners of the embodiments of FIGS. 2A and B are not shown as prominently, it is nonetheless clear that the fastener in FIG. 2A is sized and shaped to position the lower electrical connector in the vicinity of the lower boundary 24 of shirt 22, and the fastener in FIG. 2B is sized and shaped to position the lower electrical connector in the vicinity of a side boundary 26 of shirt 22. In both embodiments, the fastener is sized and shaped to position first upper electrical connector 46a and second upper electrical connector 46b in the vicinity of the neck area of the shirt. Because first upper electrical connector 46a and second upper electrical connector 46b are positioned so close to the user's ears, electrical leads 34a, 34b may be sized to be shorter than 25 cm., which reduces the likelihood that loose wires would wrap around an object and/or impede the user's head movement.

With reference again to FIG. 3, fastener 50 includes a strip of fabric 52, which has strip segments 52a, 52b, and 52c joining at a common point 54. An adhesive on the underside (not shown) effects the attachment of fastener 50 to shirt 22. In some embodiments of the invention, a heat activated adhesive is used, so a common household iron may be implemented to attach audio extension cord 40 to shirt 22. Also in some embodiments, electrical leads 42 are sewn to the fastener.

In the embodiment of FIG. 3, electrical leads 42 extend in a zigzag pattern to allow the leads to stretch and conform more easily to changing bodily shapes while the user moves. The term zigzag is used in the present disclosure as a description of a path that proceeds in sharp or gradual turns in alternating directions. Such a path provides slack in the leads to facilitate the conformance to changing bodily shapes.

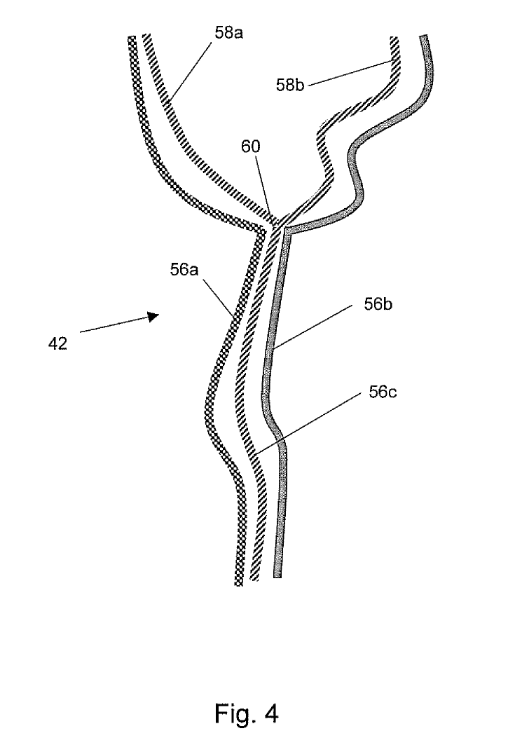

Reference is now made to FIG. 4 for the following description of electrical leads 42 of audio extension cord 40. In this embodiment, electrical leads 42 are a set of three leads. A first lead 56a extends from lower electrical connector 43 to first upper electrical connector 46a, and a second lead 56b extends from lower electrical connector 43 to second upper electrical connector 46b. A third lead 56c extends from lower electrical connector 43 and separates into first and second lead segments 58a, 58b at separation point 60 in the region of the middle of the back of shirt 22. First lead segment 58a extends up to first upper electrical connector 46a, and second lead segment 58b extends up to second upper electrical connector 46b.

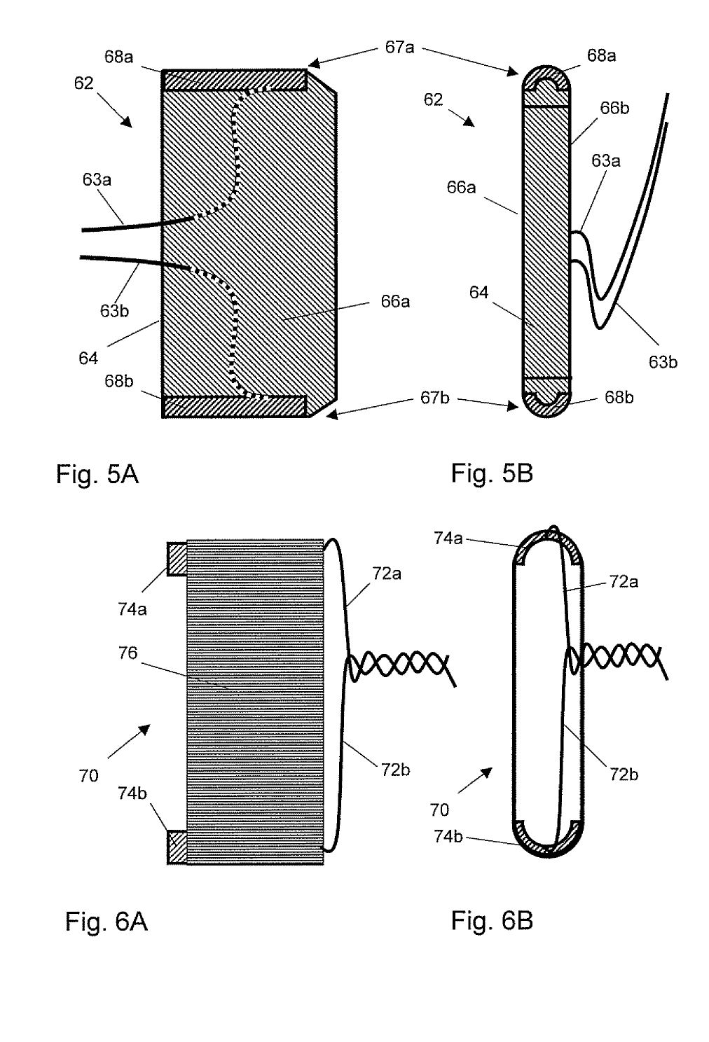

Reference is now made to FIGS. 5A and 513, which show a side and front view, respectively, of an embodiment of an upper electrical connector 62 of an audio extension cord, and to FIGS. 6A and 6B, which show a side and front view, respectively, of an embodiment of a connector 70 of a headset. Note that the male connector is the connector affixed to the shirt and that the female connector is the connector affixed to the headset. Because the connector affixed to the shirt is not the female connector, there is no concave portion to accumulate water during the washing of the shirt and to retain the water thereafter.

As shown in FIGS. 5A and 5B, upper electrical connector 62 receives two electrical leads 63a, 63b of the audio extension cord and encases the ends of the leads in an insulating plate 64. Insulating plate 64 is substantially flat; thus, two opposite sides 66a, 66b of insulating plate 64 have significantly greater surface area than the remaining sides. Of the remaining sides, two opposite sides 67a, 67b are connected to electrodes 68a, 68b, respectively. Electrical leads 63a, 63b are electrically connected to electrodes 68a, 68b, respectively.

FIGS. 6A and 613 show connector 70 receiving two electrical leads 72a, 72b of the headset. Electrical leads 72a, 72b are connected to conducting cap members 74a, 74b, which are spaced apart by an internal structure (not shown) of connector 70. Conducting cap members 74a, 74b are pulled away from each other slightly when upper electrical connector 62 of the audio extension cord is inserted therein, and an elastic band 76 pulls conducting cap members 74a, 74b toward each other to maintain electrical contact with electrodes 68a, 68b, respectively.

In this embodiment, upper electrical connector 62 of an audio extension cord and connector 70 of a headset are made substantially flat to reduce any discomfort that the user might feel, for example, if a heavy coat were placed snugly around the shirt on which the connectors were mounted. Connector 70 may have a padded body to reduce further such discomfort. Elastic band 76 may be made of a material to provide such padding. In alternate embodiments, where the audio extension cord has the female connector and the headset has the male connector, the upper electrical connector of the audio extension cord may have the padded body.

In the present embodiment upper electrical connector 62 is fashioned with electrodes 68a, 68b having different sizes, and connector 70 is correspondingly fashioned with conducting cap members 74a, 74b having different sizes to ensure that that the ground lead and the left/right lead of the audio extension cord are properly connected to the ground lead and the left/right lead of the headset. That is, an attempt to join the connectors in a fashion to reverse the polarity would be unsuccessful due to a size mismatch of the electrodes and the conducting cap members. Headsets having two earphones may be further fashioned so that the two upper electrical connectors of the audio extension cord are made with differing sizes and that the two connectors of the headset are also made with differing sizes to prevent the left earphone from mating with the right lead of the audio extension cord and vice versa.

Other embodiments of the invention include methods of attaching an audio extension cord to a shirt to facilitate listening to a portable audio player located at or near a side or lower boundary of the shirt. One of such methods includes sewing a set of electrical leads to extend from the vicinity of the side or lower boundary of the shirt to the vicinity of a neck area of the shirt (No fastener 50 is necessary in this embodiment.) A lower electrical connector, compatible with an output connector of the portable audio player, is connected to a bottom end of the set of leads. A first upper electrical connector, compatible with an electrical connector of a first earphone, is connected to a first upper end of the set of leads. If the audio extension cord is designed for a headset having two earphones, the method includes connecting a second upper electrical connector, compatible with an electrical connector of a second earphone, to a second upper end of the set of leads.

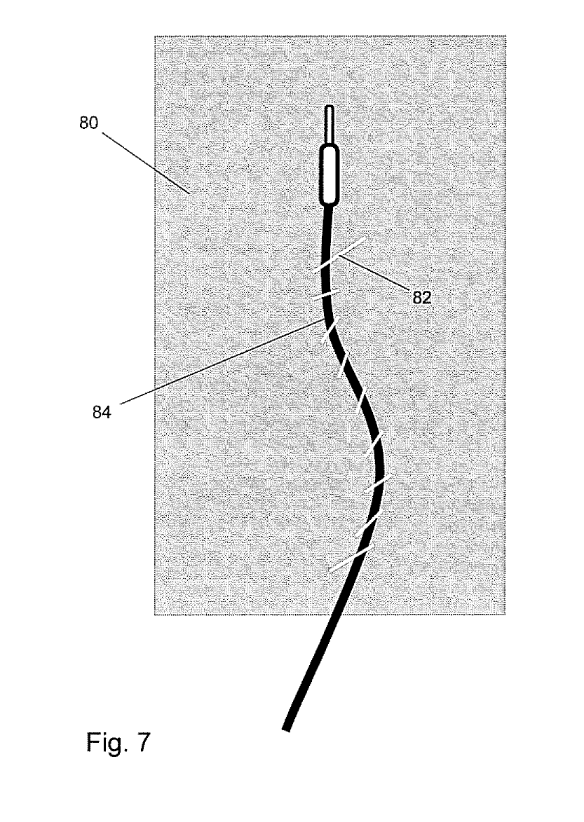

One way of sewing the set of electrical leads is to lead a thread through the shirt and to wrap the thread around the set of leads. FIG. 7 shows the fabric 80 of a shirt in which a thread 82 was lead therethrough and wrapped about a lead 84.

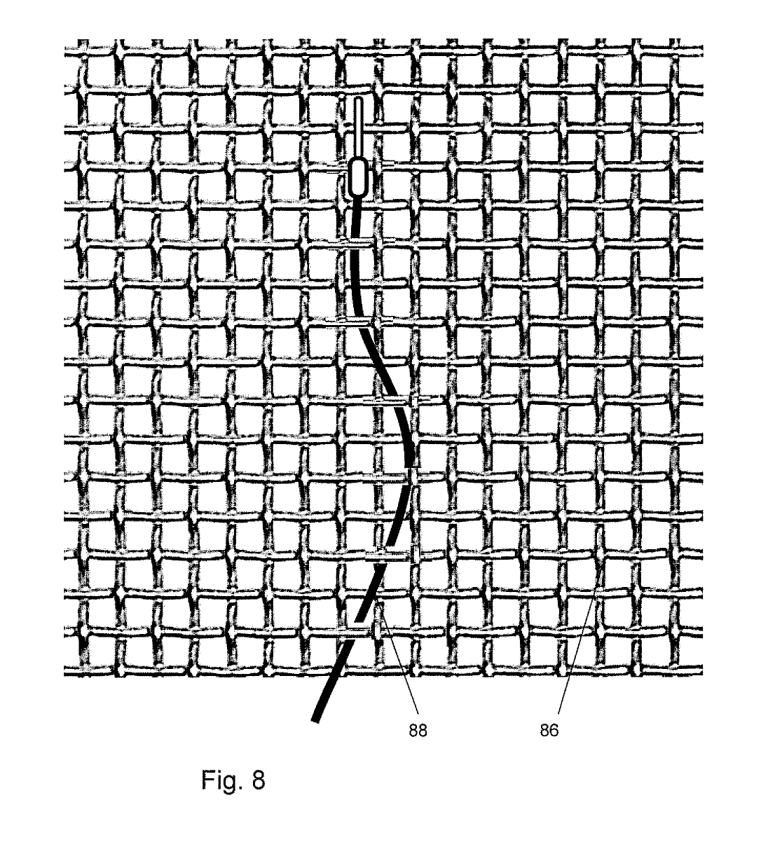

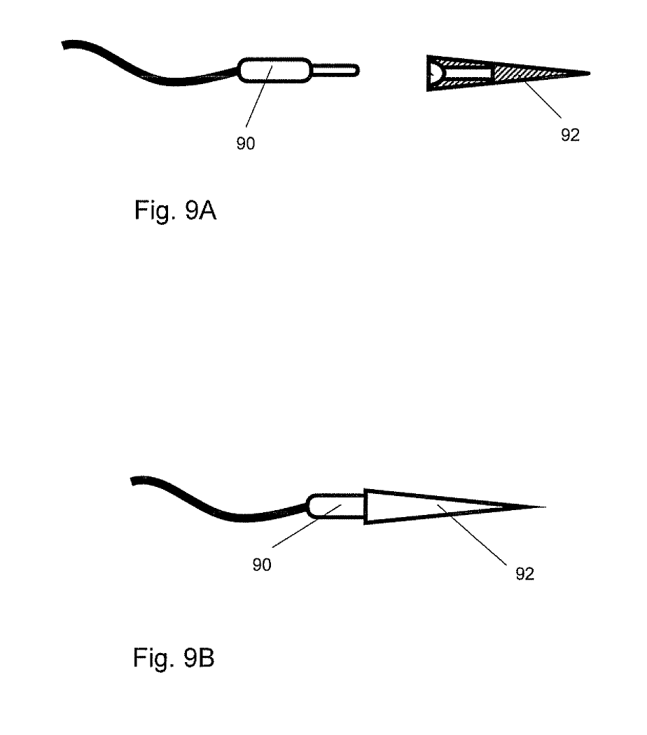

Another way of sewing the set of electrical leads, for relatively loosely-woven fabrics such as that of sweaters, is to lead the set of leads itself through the shirt. FIG. 8 shows loosely-woven fabric 86 in which a lead 88 was led therethrough. In some embodiments, for fabrics with loose enough weaving, the threading of the leads therethrough may be facilitated by attaching a tapered cap to one or more electrical connectors to act as a needle. FIG. 9A shows an electrical connector 90 and a corresponding tapered cap 92, the two elements not being attached to each other. FIG. 9B shows the two elements in their connected state. Of course, the leads may instead be sewn to the shirt before electrical connectors are connected.

Having thus described exemplary embodiments of the invention, it will be apparent that various alterations, modifications, and improvements will readily occur to those skilled in the art. Alternations, modifications, and improvements of the disclosed invention, though not expressly described above, are nonetheless intended and implied to be within spirit and scope of the invention. Accordingly, the foregoing discussion is intended to be illustrative only; the invention is limited and defined only by the following claims and equivalents thereto.

We claim:

1. An audio extension cord for connecting a portable audio player located at or near a side or lower boundary of a shirt to at least one earphone located at or near a neck area of the shirt, the audio extension cord comprising:
a set of electrical leads;
a lower electrical connector connected to a bottom end of said set of leads, said lower electrical connector being compatible with an output connector of the portable audio player;
a first upper electrical connector connected to a first upper end of said set of leads, said first upper electrical connector being compatible with a first connector of the at least one earphone; and
a fastener configured to fasten said electrical leads to the shirt, said fastener extending along the majority of the length of said set of leads,
wherein said fastener is sized and shaped: (1) to position said lower electrical connector in the vicinity of the side or lower boundary of the shirt, and (2) to position said first upper electrical connector in the vicinity of the neck area of the shirt.

2. The audio extension cord of claim 1, wherein said fastener is sized and shaped to position the lower electrical connector in the vicinity of the side boundary of the shirt.

3. The audio extension cord of claim 1, wherein said fastener is sized and shaped to position the lower electrical connector in the vicinity of the lower boundary of the shirt.

4. The audio extension cord of claim 1, wherein said fastener comprises a strip of fabric.

5. The audio extension cord of claim 4, wherein said strip of fabric comprises three strip segments joining at a common point.

6. The audio extension cord of claim 1, wherein said fastener comprises an adhesive.

7. The audio extension cord of claim 6, wherein said adhesive is a heat activated adhesive.

8. The audio extension cord of claim 1, wherein said set of leads is sewn to said fastener.

9. The audio extension cord of claim 1, wherein said set of leads extend in a zigzag pattern.

10. The audio extension cord of claim 1, further comprising:
a second upper electrical connector connected to a second upper end of said set of leads, said second upper electrical connector being compatible with a second connector of the at least one earphone.

11. The audio extension cord of claim 10, wherein said first upper electrical connector and said second upper electrical connector differ in such a fashion that they cannot mate with the same earphone connector.

12. The audio extension cord of claim 10, wherein said set of leads are configured such that:
a first lead of said set extends from said lower electrical connector to said first upper electrical connector;
a second lead of said set extends from said lower electrical connector to said second upper electrical connector; and
a third lead of said set extends from said lower electrical connector and separates into two lead segments, the first of said lead segments extending up to said first upper electrical connector, and the second of said lead segments extending up to said second upper electrical connector.

13. The audio extension cord of claim 1, wherein said first upper electrical connector is a male connector.

14. The audio extension cord of claim 1, wherein said first upper electrical connector is substantially flat.

15. The audio extension cord of claim 1, wherein said first upper electrical connector has a padded body.

16. A headset having at least one earphone, the headset comprising:
a first speaker;
a first set of electrical leads; and
a first female connector,
wherein said first set of leads connects said first speaker to said first female connector.

17. The headset claim 16 further comprising:
a second speaker;
a second set of electrical leads; and
a second female connector,
wherein said second set of leads connects said second speaker to said second female connector.

18. The headset of claim 17, wherein said first female connector and said second female connector differ in such a fashion that they cannot mate with the same male connector.

19. The headset of claim 16, wherein said first female connector is substantially flat.

20. The headset of claim 17, wherein said first female connector and said second female connector are substantially flat.

21. The headset of claim 16, wherein said first female connector is padded.

22. The headset of claim 17, wherein said first female connector and said second female connector are padded.

23. The headset of claim 16, wherein the said first set of leads is shorter than 25 cm.

24. The headset of claim 17, wherein said first set of leads and said second set of leads are shorter than 25 cm.

25. An audio arrangement for adapting a shirt to facilitate listening to a portable audio player located at or near a side or lower boundary of the shirt, the audio arrangement comprising:
a headset having at least one earphone and a first headset connector; and
an audio extension cord having:
a set of electrical leads;
a lower electrical connector connected to a bottom end of said set of leads, said lower electrical connector being compatible with an output connector of the portable audio player;
a first upper electrical connector connected to a first upper end of said set of leads, said first upper electrical connector being compatible with said first headset connector; and
a fastener configured to fasten said set of leads to the shirt, said fastener extending along the majority of the length of said set of leads,
wherein said fastener is sized and shaped: (1) to position said lower electrical connector in the vicinity of the side or lower boundary of the shirt, and (2) to position said first upper electrical connector in the vicinity of the neck area of the shirt.

26. The audio arrangement of claim 25, wherein said headset further comprises a second headset connector, and wherein said audio extension cord further comprises a second upper electrical connector connected to a second upper end of said set of leads, said second upper electrical connector being compatible with said second headset connector.

27. A method of attaching an audio extension cord to a shirt to facilitate listening to a portable audio player located at or near a side or lower boundary of the shirt, the method comprising:
sewing a set of electrical leads to extend from the vicinity of the side or lower boundary of the shirt to the vicinity of a neck area of the shirt;
connecting a lower electrical connector to a bottom end of said set of leads, said lower electrical connector being compatible with an output connector of the portable audio player; and
connecting a first upper electrical connector to a first upper end of said set of leads, said first upper electrical connector being compatible with an electrical connector of a first earphone.

28. The method of claim 27 further comprising:
connecting a second upper electrical connector to a second upper end of said set of leads, said second upper electrical connector being compatible with an electrical connector of a second earphone.

29. The method of claim 27, wherein said sewing is effected by leading a thread through the shirt and wrapping said thread around said set of leads.

30. The method of claim 27, wherein said sewing is effected by leading said set of leads through the shirt.

31. The method of claim 30, wherein said leading is effected by attaching a tapered cap to said lower electrical connector, to said first upper electrical connector, or to both.
